(19) United States
(12) Patent Application Publication
(10) Pub. No.: US 2012/0123005 A1
(43) Pub. Date: May 17, 2012

(54) NATURAL OIL BASED POLYURETHANE FOAMS

(75) Inventors: Bruno Cesar Motta, Sao Paulo (BR); Marcos Franca, Sao Paulo (BR); Vinicius Serves, Santo Andre (BR); Paul Cookson, Samstagern (CH); Imran Munshi, Au (CH); Francois M. Casati, Pfaffikon (CH)

(73) Assignees: Dow Brasil Sudeste Industrial Ltda., Sao Paulo/Sp (BR); Dow Global Technologies LLC, Midland, MI (US); DOW BRAZIL S.A., Sao Paulo-Sp (BR)

(21) Appl. No.: 13/384,927

(22) PCT Filed: Jul. 22, 2010
(86) PCT No.: PCT/US10/42878

§ 371 Date: Jan. 19, 2012

Related U.S. Application Data
(60) Provisional application No. 61/227,575, filed on Jul. 22, 2009.

(51) Int. Cl. C08G 18/06

(52) U.S. Cl. 521/112

(57) ABSTRACT

The embodiments of the present invention provide for polyurethane foams that include renewable resources while keeping desired properties of the polyurethane product. For example, described herein, according to embodiments of the invention, are polyurethane foams that have a high concentration of renewable resources while retaining favorable airflow, tensile strength, tear resistance, elongation, indentation force deflection, and/or resilience. These foams may also posses improved yellowing resistance and improved water absorption rates.

### BACKGROUND

1. Field of the Invention

Embodiments of the present invention generally relate to polyurethane foams; more specifically, to natural resource based flexible foams.

2. Description of the Related Art

Polyether polyols based on the polymerization of alkylene oxides, polyester polyols, or combinations thereof, are together with isocyanates the major components of a polyurethane system. One class of polyols are conventional petroleum-based polyols, and another class are those polyols made from vegetable oils or other renewable feedstocks (so-called natural oil based polyols, or NOPB). Polyols based on renewable feedstocks may be sold and marketed as a component of polyol blends which often also may include conventional petroleum-based polyols as well as catalysts and other additives. These blends are then reacted with the isocyanates to form foams or other polyurethane products. However, using natural oil based polyols in high concentrations may in certain instances result in a reduced quality of the foam or foaming process. Therefore, there is a need for a method of producing polyurethane foams that result in an increased amount of renewable resources in the final polyurethane product while maintaining the foam's quality.

### SUMMARY

The embodiments of the present invention provide for polyurethane foams made by reacting at least one isocyanate with at least one natural oil based polyol in the presence of at least one polyalkylene oxide polysiloxane.

In an alternative embodiment, a polyurethane foam is provided, and includes a reaction product at least one isocyanate and at least one natural oil based polyol. The at least one isocyanate and the at least one natural oil based polyol are reacted in the presence of at least one polyalkylene oxide polysiloxane having the formula:

R¹—CH₃)₂SiO—[(CH₃)₂SiO]ₐ—[CH₃)(R¹)SiO]_{b}—Si(CH₃)₂R¹

wherein a+b are from about 1 to about 50, and each R¹ is the same or different and is selected from the group consisting of methyl and a poly(ethyleneoxide/propyleneoxide) copolymer group having the general formula:

—(CH₂)ₙO(C₂H₄O)_{c}(C₃H₆O)_{d}R²

with at least one R¹ being a poly(ethyleneoxide/propyleneoxide) copolymer group, and wherein n is 3 or 4, total c has a value of from 1 to about 100, total d is from 0 to about 14, total c+d has a value of from about 5 to about 150, and each R² is the same or different and is selected from the group consisting of hydrogen, an alkyl having 1 to 4 carbon atoms, and an acetyl group.

In an alternative embodiment, a polyurethane foam is provided, and includes, the reaction product of at least one isocyanate and at least one natural oil based polyol. The polyurethane foam has a renewable carbon content of at least about 10% and a resilience of at least of about 35%, and the at least one isocyanate and the at least one natural oil based polyol are reacted in the presence of at least one polyalkylene oxide polysiloxane having the formula:

R¹—CH₃)₂SiO—[(CH₃)₂SiO]ₐ—[(CH₃)(R¹)SiO]_{b}—Si(CH₃)₂R¹

wherein a+b are from about 1 to about 50, and each R¹ is the same or different and is selected from the group consisting of methyl and a poly(ethyleneoxide/propyleneoxide) copolymer group having the general formula:

—(CH₂)ₙO(C₂H₄O)_{c}(C₃H₆O)_{d}R²

with at least one R¹ being a poly(ethyleneoxide/propyleneoxide) copolymer group, and wherein n is 3 or 4, total c has a value of from 1 to about 100, total d is from 0 to about 14, total c+d has a value of from about 5 to about 150, and each R² is the same or different and is selected from the group consisting of hydrogen, an alkyl having 1 to 4 carbon atoms, and an acetyl group.

In an alternative embodiment, a method for producing the polyurethane foam is provided, and includes reacting at least one isocyanate with at least one natural oil based polyol. The at least one isocyanate and the at least one natural oil based polyol are reacted in the presence of at least one polyalkylene oxide polysiloxane having the formula:

R¹—CH₃)₂SiO—[(CH₃)₂SiO]ₐ—[(CH₃)(R¹)SiO]_{b}—Si(CH₃)₂R¹

wherein a+b are from about 1 to about 50, and each R¹ is the same or different and is selected from the group consisting of methyl and a poly(ethyleneoxide/propyleneoxide) copolymer group having the general formula:

—(CH₂)ₙO(C₂H₄O)_{c}(C₃H₆O)_{d}R²

with at least one R¹ being a poly(ethyleneoxide/propyleneoxide) copolymer group, and wherein n is 3 or 4, total c has a value of from 1 to about 100, total d is from 0 to about 14, total c+d has a value of from about 5 to about 150, and each R² is the same or different and is selected from the group consisting of hydrogen, an alkyl having 1 to 4 carbon atoms, and an acetyl group.

### DETAILED DESCRIPTION

The embodiments of the present invention satisfy the needs for producing polyurethane foams that result in an increased amount of renewable resources in the final polyurethane product while also keeping desired properties of the polyurethane product. For example, described herein, according to embodiments of the invention, are polyurethane foams that have a high concentration of renewable resources while retaining favorable airflow, tensile strength, tear resistance, elongation, indentation force deflection, and/or resilience. These foams may also posses improved yellowing resistance and improved water absorption rates.

These high renewable resource polyurethane foams may be formed by reacting at least one isocyanate and at least one polyol in the presence of at least polyalkylene oxide polysiloxane. The at least one polyol may include at least one natural oil based polyol.

Natural oil based polyols (NOBP) are polyols based on or derived from renewable feedstock resources such as natural and/or genetically modified (GMO) plant vegetable seed oils and/or animal source fats. Such oils and/or fats are generally comprised of triglycerides, that is, fatty acids linked together with glycerol. Preferred are vegetable oils that have at least about 70 percent unsaturated fatty acids in the triglyceride. Preferably the natural product contains at least about 85 percent by weight unsaturated fatty acids. Examples of preferred vegetable oils include, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or a combination thereof. Examples of animal products include lard, beef tallow, fish oils and mixtures thereof. Additionally, oils obtained from organisms such as algae may also be used. A combination of vegetable, algae, and animal based oils/fats may also be used.

For use in the production of polyurethane foams, the natural material may be modified to give the material isocyanate reactive groups or to increase the number of isocyanate reactive groups on the material. Preferably such reactive groups are a hydroxyl group.

The modified natural oil derived polyols may be obtained by a multi-step process wherein the animal or vegetable oils/fats are subjected to transesterification and the constituent fatty acids recovered. This step is followed by hydroformylating carbon-carbon double bonds in the constituent fatty acids to form hydroxymethyl groups. Suitable hydroformylation methods are described in U.S. Pat. Nos. 4,731,486 and 4,633,021, for example, and in U.S. Patent Application No. 2006/0193802. The hydroxymethylated fatty acids are herein labeled “monomers” which form one of the building blocks for the natural oil based polyol. The monomers may be a single kind of hydroxymethylated fatty acid and/or hydroxymethylated fatty acid methyl ester, such as hydroxymethylated oleic acid or methylester thereof, hydroxymethylated linoleic acid or methylester thereof, hydroxymethylated linolenic acid or methylester thereof, α- and γ-linolenic acid or methyl ester thereof, myristoleic acid or methyl ester thereof, palmitoleic acid or methyl ester thereof, oleic acid or methyl ester thereof, vaccenic acid or methyl ester thereof, petroselinic acid or methyl ester thereof, gadoleic acid or methyl ester thereof, erucic acid or methyl ester thereof, nervonic acid or methyl ester thereof, stearidonic acid or methyl ester thereof, arachidonic acid or methyl ester thereof, timnodonic acid or methyl ester thereof, clupanodonic acid or methyl ester thereof, cervonic acid or methyl ester thereof, or hydroxymethylated ricinoleic acid or methylester thereof. In one embodiment, the monomer is hydroformulated methyloelate. Alternatively, the monomer may be the product of hydroformylating the mixture of fatty acids recovered from transesterifaction process of the animal or vegetable oils/fats. In one embodiment the monomer is hydroformulated soy bean fatty acids. In another embodiment the monomer is hydroformulated castor bean fatty acids. In another embodiment, the monomer may be a mixture of selected hydroxymethylated fatty acids or methylesters thereof.

A polyol is then formed by reacting the monomer with an appropriate initiator compound to form a polyester or polyether/polyester polyol. Such a multi-step process is commonly known in the art, and is described, for example, in PCT publication Nos. WO 2004/096882 and 2004/096883. The multi-step process results in the production of a polyol with both hydrophobic and hydrophilic moieties, which results in enhanced miscibility with both water and conventional petroleum-based polyols.

The initiator for use in the multi-step process for the production of the natural oil derived polyols may be any initiator used in the production of conventional petroleum-based polyols. Preferably the initiator is selected from the group consisting of neopentylglycol; 1,2-propylene glycol; trimethylolpropane; pentaerythritol; sorbitol; sucrose; glycerol; aminoalcohols such as ethanolamine, diethanolamine, and triethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol and combination thereof. More preferably the initiator is selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. More preferably, the initiator is glycerol, trimethylopropane, pentaerythritol, sucrose, sorbitol, and/or mixture thereof.

In one embodiment, the initiators are alkoxlyated with ethylene oxide or a mixture of ethylene and at least one other alkylene oxide to give an alkoxylated initiator with a molecular weight between about 200 and about 6000, preferably between about 500 and about 5000. In one embodiment the initiator has a molecular weight of about 550, in another embodiment the molecular weight is about 625, and in yet another embodiment the initiator has a molecular weight of about 4600.

In one embodiment, at least one initiator is a polyether initiator having an equivalent weight of at least about 400 or an average at least about 9.5 ether groups per active hydrogen group, such initiators are described in copending Patent Application No. PCT/US09/37751, filed on Mar. 20, 2009, entitled “Polyether Natural Oil Polyols and Polymers Thereof” the entire contents of which are incorporated herein by reference.

The ether groups of the polyether initiator may be in poly(alkylene oxide) chains, such as in poly(propylene oxide) or poly(ethylene oxide) or a combination thereof. In one embodiment, the ether groups may be in a diblock structure of poly(propylene oxide) capped with poly(ethylene oxide).

In one embodiment, a NOPB is made with an initiator or combination of initiators having an average equivalent weight of between about 400 and about 3000 per active hydrogen group. All individual values and subranges between about 400 and about 3000 per active hydrogen group are included herein and disclosed herein; for example, the average equivalent weight can be from a lower limit of about 400, 450, 480, 500, 550, 600, 650, 700, 800, 900, 1000, 1200, or 1300 to an upper limit of about 1500, 1750, 2000, 2250, 2500, 2750, or 3000 per active hydrogen group.

Thus, in this embodiment, at least two of the natural oil based monomers are separated by a molecular structure having an average molecular weight of between about 1250 Daltons and about 6000 Daltons. All individual values and subranges between about 1250 Daltons and about 6000 Daltons are included herein and disclosed herein; for example, the average molecular weight can be from a lower limit of about 1250, 1500, 1750, 2000, 2250, 2500, 2750, 3000, or Daltons to an upper limit of about 3000, 3500, 4000, 4500, 5000, 5500, or 6000 Daltons.

To form the polyether initiator, the active hydrogen groups may be reacted with at least one alkylene oxide, such ethylene oxide or propylene oxide or a combination thereof; or a block of propylene oxide followed by a block of ethylene oxide, to form a polyether polyol by means within the skill in the art. The polyether initiator is may be used as an initiator for reaction with at least one natural oil based monomer. Alternatively the initiator is reacted by means within the skill in the art to convert one or more hydroxyl groups to alternative active hydrogen groups, such as is propylene oxide.

Other initiators include other linear and cyclic compounds containing an amine. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine various isomers of toluene diamine; diphenylmethane diamine; N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, N,N-dimethyldipropylenetriamine, aminopropyl-imidazole.

Thus, in an embodiment, the natural oil based polyol may comprise at least two natural oil moieties separated by a molecular structure having at least about 19 ether groups or having an equivalent weight of at least about 400, preferably both. When the polyether initiator has more than 2 active hydrogen groups reactive with the natural oil or derivative thereof, each natural oil moiety is separated from another by an average of at least about 19 ether groups or a structure of molecular weight of at least about 400, preferably both.

The functionality of the resulting natural oil based polyols is above about 1.5 and generally not higher than about 6. In one embodiment, the functionality is below about 4. The hydroxyl number of the of the natural oil based polyols may be below about 300 mg KOH/g, preferably between about 50 and about 300, preferably between about 60 and about 200. In one embodiment, the hydroxyl number is below about 100.

The level of renewable feedstock in the natural oil based polyol can vary between about 10 and about 100%, usually between about 10 and about 90%. In a flexible foam, the natural oil based polyol may often constitute at least 5 weight %, at least 10 weight %, at least 25 weight %, at least 35 weight %, at least 40 weight %, at least 50 weight %, at least 60 weight %, at least 70 weight %, at least 80 weight %, at least 90 weight %, or at least 95 weight % of the total weight of the polyol. The natural oil based polyols may constitute 40% or more, 50 weight % or more, 60 weight % or more, 75 weight % or more, 85 weight % or more, 90 weight % or more, 95 weight % or more, or 99 weight % or more of the total weight of the polyols. The viscosity measured at 25° C. of the natural oil derived polyols is generally less than about 6,000 mPa·s. Preferably, the viscosity is less than about 5,000 mPa·s.

The polyol may optionally include another kind of polyol, which includes at least one conventional petroleum-based polyol. The at least one conventional petroleum-based polyol includes materials having at least one group containing an active hydrogen atom capable of undergoing reaction with an isocyanate, and not having parts of the material derived from a vegetable or animal oil. Suitable conventional petroleum-based polyols are well known in the art and include those described herein and any other commercially available polyol. Mixtures of one or more polyols and/or one or more polymer polyols may also be used to produce polyurethane products according to embodiments of the present invention.

Representative polyols include polyether polyols, polyester polyols, polyhydroxy-terminated acetal resins, hydroxyl-terminated amines and polyamines. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound. The initiators suitable for the natural oil based polyols may also be suitable for the at least one conventional petroleum-based polyol.

The at least one conventional petroleum-based polyol may for example be poly(propylene oxide) homopolymers, random copolymers of propylene oxide and ethylene oxide in which the poly(ethylene oxide) content is, for example, from about 1 to about 30% by weight, ethylene oxide-capped poly(propylene oxide) polymers and ethylene oxide-capped random copolymers of propylene oxide and ethylene oxide. For slabstock foam applications, such polyethers preferably contain 2-5, especially 2-4, and preferably from 2-3, mainly secondary hydroxyl groups per molecule and have an equivalent weight per hydroxyl group of from about 400 to about 3000, especially from about 800 to about 1750. For high resiliency slabstock and molded foam applications, such polyethers preferably contain 2-6, especially 2-4, mainly primary hydroxyl groups per molecule and have an equivalent weight per hydroxyl group of from about 1000 to about 3000, especially from about 1200 to about 2000. When blends of polyols are used, the nominal average functionality (number of hydroxyl groups per molecule) will be preferably in the ranges specified above. For viscoelastic foams shorter chain polyols with hydroxyl numbers above 150 are also used. For the production of semi-rigid foams, it is preferred to use a trifunctional polyol with a hydroxyl number of 30 to 80.

The polyether polyols may contain low terminal unsaturation (for example, less that 0.02 meq/g or less than 0.01 meq/g), such as those made using so-called double metal cyanide (DMC) catalysts. Polyester polyols typically contain about 2 hydroxyl groups per molecule and have an equivalent weight per hydroxyl group of about 400-1500.

The conventional petroleum-based polyols may be a polymer polyol. In a polymer polyol, polymer particles are dispersed in the conventional petroleum-based polyol. Such particles are widely known in the art an include styrene-acrylonitrile (SAN), acrylonitrile (ACN), polystyrene (PS), methacrylonitrile (MAN), or methyl methacrylate (MMA) particles. In one embodiment the polymer particles are SAN particles.

The conventional petroleum-based polyols may constitute up to about 10 weight %, 20 weight %, 30 weight %, 40 weight %, 50 weight %, or 60 weight % of polyol formulation. The conventional petroleum-based polyols may constitute at least about 0.5 weight %, 1 weight %, 5 weight %, 10 weight %, 20 weight %, 30 weight %, or 50 weight % of the polyol blend.

The at least one polyol may be reacted with at least one isocyanate in the presence of at least one polyalkylene oxide polysiloxane. Polyalkylene oxide polysiloxanes have a dimethyl polysiloxane hydrophobic moiety and one or more hydrophilic polyalkylene side chains. The polyalkylene oxide polysiloxanes have the general formula:

R¹—CH₃)₂SiO—[(CH₃)₂SiO]ₐ—[(CH₃)(R¹)SiO]_{b}—Si(CH₃)₂R¹

wherein a+b are from about 1 to about 50, preferably from about 3 to about 30, preferably from about 10 to about 25, and each R¹ is the same or different and is selected from the group consisting of methyl and a poly(ethyleneoxide/propyleneoxide) copolymer group having the general formula:

—(CH₂)ₙO(C₂H₄O)_{c}(C₃H₆O)_{d}R²

with at least one R¹ being a poly(ethyleneoxide/propyleneoxide) copolymer group, and wherein n is 3 or 4, preferably 3; total c (for all polyalkyleneoxy side groups) has a value of from 1 to about 100, preferably from about 6 to about 100; total d is from 0 to about 14, preferably from 0 to about 3; and more preferably d is 0; total c+d has a value of from about 5 to about 150, preferably from about 9 to about 100 and each R² is the same or different and is selected from the group consisting of hydrogen, an alkyl having 1 to 4 carbon atoms, and an acetyl group, preferably hydrogen and methyl group. Such polyalkylene oxide polysiloxanes are described in for example U.S. Pat. Nos. 5,595,957 and 5,968,404.

Nonlimiting examples of such type of surfactants may be the SILWET surfactants which are available from Momentive Performance Materials, SYLGARD available from Dow Corning Corporation, QWIKWET and SURFLEX available from Exacto Inc., or BREAK THRU available from Evonik Industries. In one embodiment, a SILWET surfactant has the CAS number 67762-85-0.

In one embodiment, the polyalkylene oxide polysiloxane may have an average molecular weight of less than about 10,000. In one embodiment, the average molecular weight may be between about 2000 and about 7000.

For the production of a polyurethane foam the polyol may be combined in a foam formulation with additional ingredients such as catalysts, crosslinkers, emulsifiers, preservatives, flame retardants, colorants, antioxidants, reinforcing agents, fillers, including recycled polyurethane foam in form of powder.

Any suitable urethane catalyst may be used, including tertiary amine compounds, amines with isocyanate reactive groups and organometallic compounds. Exemplary tertiary amine compounds include triethylenediamine, N-methylmorpholine, N,N-dimethylcyclohexyl amine, pentamethyldiethylenetriamine, tetramethyl-ethylenediamine, bis(dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate. A catalyst for the trimerization of isocyanates, resulting in a isocyanurate, such as an alkali metal alkoxide may also optionally be employed herein. The amount of amine catalysts can vary from 0 to about 5 percent in the formulation or organometallic catalysts from about 0.001 to about 1 percent in the formulation can be used.

One or more crosslinkers may be provided, in addition to the polyols described above. This is particularly the case when making high resilience slabstock or molded foam. If used, suitable amounts of crosslinkers are from about 0.1 to about 1 part by weight, especially from about 0.25 to about 0.5 part by weight, per 100 parts by weight of polyols.

The crosslinkers may have three or more isocyanate-reactive groups per molecule and an equivalent weight per isocyanate-reactive group of less than 400. The crosslinkers preferably may include from 3-8, especially from 3-4 hydroxyl, primary amine or secondary amine groups per molecule and have an equivalent weight of from 30 to about 200, especially from 50-125. Examples of suitable crosslinkers include diethanol amine, monoethanol amine, triethanol amine, mono- di- or tri(isopropanol) amine, glycerine, trimethylol propane, pentaerythritol, and sorbitol.

It is also possible to use one or more chain extenders in the foam formulation. The chain extender may have two isocyanate-reactive groups per molecule and an equivalent weight per isocyanate-reactive group of less than 400, especially from 31-125. The isocyanate reactive groups are preferably hydroxyl, primary aliphatic or aromatic amine or secondary aliphatic or aromatic amine groups. Representative chain extenders include amines ethylene glycol, diethylene glycol, 1,2-propylene glycol, dipropylene glycol, tripropylene glycol, ethylene diamine, phenylene diamine, bis(3-chloro-4-aminophenyl)methane and 2,4-diamino-3,5-diethyl toluene. If used, chain extenders are typically present in an amount from about 1 to about 50, especially about 3 to about 25 parts by weight per 100 parts by weight high equivalent weight polyol.

A polyether polyol may also be included in the foam formulation, i.e, as part of the at least one conventional petroleum-based polyol, to promote the formation of an open-celled or softened polyurethane foam. Such cell openers generally have a functionality of 2 to 12, preferably 3 to 8, and a molecular weight of at least 5,000 up to about 100,000. Such polyether polyols contains at least 50 weight percent oxyethylene units, and sufficient oxypropylene units to render it compatible with the components. The cell openers, when used, are generally present in an amount from 0.2 to 5, preferably from 0.2 to 3 parts by weight of the total polyol. Examples of commercially available cell openers are VORANOL Polyol CP 1421 and VORANOL Polyol 4053; VORANOL is a trademark of The Dow Chemical Company.

The at least one polyol may then be reacted with at least one isocyanate to form a flexible polyurethane foam. Isocyanates which may be used in the present invention include aliphatic, cycloaliphatic, arylaliphatic and aromatic isocyanates.

Examples of suitable aromatic isocyanates include the 4,4′-, 2,4′ and 2,2′-isomers of diphenylmethane diisocyante (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, 1,3-bis(isocyanatomethyl)cyclohexane, 1,4-bis(isocyanatomethyl)cyclohexane, saturated analogues of the above mentioned aromatic isocyanates, and mixtures thereof.

The at least one isocyanate is added to the foam formulation for an isocyanate index of between about 30 and about 150, preferably between about 50 and about 120, more preferably between about 60 and about 110. The isocyanate index is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

For the production of flexible foams, the polyisocyanates may often be the toluene-2,4- and 2,6-diisocyanates or MDI or combinations of TDI/MDI or prepolymers made therefrom.

Isocyanate tipped prepolymer may also be used in the polyurethane formulation. Such prepolymers are obtained by the reaction of an excess of polyol. The polyol may be the conventional petroleum-based polyol, the natural oil derived polyol, the amine initiated polyol, and/or a combination of the polyols.

Processing for producing polyurethane products are well known in the art. In general components of the polyurethane-forming reaction mixture may be mixed together in any convenient manner, for example by using any of the mixing equipment described in the prior art for the purpose such as described in “Polyurethane Handbook”, by G. Oertel, Hanser publisher.

In general, the polyurethane foam is prepared by mixing the polyisocyanate of and polyol composition in the presence of the blowing agent, catalyst(s) and other optional ingredients as desired under conditions such that the polyisocyanate and polyol composition react to form a polyurethane and/or polyurea polymer while the blowing agent generates a gas that expands the reacting mixture. The foam may be formed by the so-called prepolymer method, in which a stoichiometric excess of the polyisocyanate is first reacted with the high equivalent weight polyol(s) to form a prepolymer, which is in a second step reacted with a chain extender and/or water to form the desired foam. Frothing methods are also suitable. So-called one-shot methods may be preferred. In such one-shot methods, the polyisocyanate and all polyisocyanate-reactive are simultaneously brought together and caused to react. Three widely used one-shot methods which are suitable for use in this invention include slabstock foam processes, high resiliency slabstock foam processes, and molded foam methods.

Slabstock foam is conveniently prepared by mixing the foam ingredients and dispensing them into a trough or other region where the reaction mixture reacts, rises freely against the atmosphere (sometimes under a film or other flexible covering) and cures. In common commercial scale slabstock foam production, the foam ingredients (or various mixtures thereof) are pumped independently to a mixing head where they are mixed and dispensed onto a conveyor that is lined with paper or plastic. Foaming and curing occurs on the conveyor to form a foam bun. The resulting foams are typically from about from about 10 kg/m³ to 80 kg/m³, especially from about 15 kg/m³ to 60 kg/m³, preferably from about 17 kg/m³ to 50 kg/m³ in density.

A preferred slabstock foam formulation contains from about 3 to about 6, preferably about 4 to about 5 parts by weight water are used per 100 parts by weight high equivalent weight polyol at atmospheric pressure. At reduced pressure these levels are reduced.

High resilience slabstock (HR slabstock) foam is made in methods similar to those used to make conventional slabstock foam but using higher equivalent weight polyols. HR slabstock foams are characterized in exhibiting a Ball rebound score of 45% or higher, per ASTM 3574.03. Water levels tend to be from about 2 to about 6, especially from about 3 to about 5 parts per 100 parts (high equivalent) by weight of polyols.

Molded foam can be made according to the invention by transferring the reactants (polyol composition including copolyester, polyisocyanate, blowing agent, and surfactant) to a closed mold where the foaming reaction takes place to produce a shaped foam. Either a so-called “cold-molding” process, in which the mold is not preheated significantly above ambient temperatures, or a “hot-molding” process, in which the mold is heated to drive the cure, can be used. Cold-molding processes are preferred to produce high resilience molded foam. Densities for molded foams generally range from 30 to 50 kg/m³.

The unique combination of the NOPB and the polyalkylene oxide polysiloxane results in enhanced control of the foam formation. For example, even when using high concentrations of NOPB, foams having uniform cell structure is obtained. Furthermore, the combination also allows for the production of foams without the use of amine catalysts which may be released as volatile organic compounds from the foam.

The foams made using NOPB in the presence of at least one polyalkylene oxide polysiloxane may have renewable carbon contents above about 10% based on the total carbon content of the foams. The renewable carbon content may be above about 10%, 15%, 20%, 25%, 30%, 35%, 40%, 45%, 50%, or 55%, The renewable carbon contents of the foams may be calculated and/or measured as described in PU Magazine, Vol. 5, No. 6, December 2008, pages 368-372.

The foams may also have an airflow of between about 0.8 cfm and about 4 cfm. All individual values and subranges between about 0.8 cfm and about 4 cfm are included herein and disclosed herein. The airflow can be from a lower limit of 0.8, 1, 1.5, 2.5, 3, or 3.5 cfm to an upper limit of 1, 1.5, 2, 2.5, 3, 3.5, or 4 cfm.

The foams may also have a tensile strength of between about 50 kPa and about 95 kPa. All individual values and subranges between about 50 kPa and about 95 kPa are included herein and disclosed herein. The tensile strength can be from a lower limit of 50, 55, 60, 65, 70, 75, 80, 85, or 90 kPa to an upper limit of 60, 65, 70, 75, 80, 85, 90, or 95 kPa.

The foams may also have a tear resistance of between about 180 N/m and about 500 N/m. All individual values and subranges between about 180 N/m and about 500 N/m are included herein and disclosed herein. The tear resistance can be from a lower limit of 180, 200, 250, 300, 350, or 400 N/m to an upper limit of 250, 300, 350, 400, 450, or 500 N/m.

The foams may also have an elongation of between about 70% and about 200%. All individual values and subranges between about 70% and about 200% are included herein and disclosed herein. The elongation can be from a lower limit of 70, 80, 90, 100, 110, 120, 130, 140, or 150% to an upper limit of 100, 110, 120, 130, 140, 150, 160, 170, 180, 190, or 200%.

The foams may also have resiliencies above about 25%, 30%, 35%, 40%, 45%, 50%, 51%, 52%, 53%, 54%, 55%, or 60%. In one embodiment the resiliency may be between about 40 and about 60%. In another embodiment the resiliency may be between about 40 and about 55%.

The foams may also have a water uptake capacity of more than 5 times the weight of the foam after immersion in water for 30 seconds. For example, the water uptake capacity of the foam may be more than 5, 6, 7, 8, 9, 10, 11, or 12 times the weight of the foam. In one embodiment, the foam absorbs about 1200% of its own weight in water.

It has also been found that because these foams are made using high amounts of natural oil based polyols, the resulting foam have an increased resistance against yellowing as compared to foams made from conventional petroleum-based polyols. Thus, it is possible to obtain yellowing resistant foams without the need for the use of expensive aliphatic isocyanates, which conventionally are used to avoid foam yellowing. For example, the foams may have reduction of CIE whiteness of less than about 50 after illumination under simulated our door light according to ISO Standard 2469 for 35 days. The reduction of CIE whiteness may be less than 45, 40, 35, or 30 over 35 days. Furthermore, the foams may after 35 days of simulated our door light according to ISO Standard 2469 have a CIE whiteness of at least 18. Alternatively, the CIE whiteness may be at least 19, 20, 21, 22, 23, 24, 25, or at least 26 after 35 days.

The foams may be suitable for example for use in bra pads, chair cushions, basket ball pole padding, bed wedges, boat seats, bolsters, bunk beds, cabin cruiser beds, camping beds, camping pads, car and truck seats, car and truck interior, case padding, chair arms and backs, church pews, concrete pipe cleaning, cot cushioning, day beds, day care toys, dinning room chairs, display models, exercise mats, fabric backing, floor padding, gymnastics or karate pads, motor home beds and seats, mattresses, motorcycle seats, packaging material, physical therapy fixtures, pillows, roll a way beds, sound proofing, scrubbers, shoulder pads, sofa cushions, sponges, wall padding, window seats.

### EXAMPLES

The following examples are provided to illustrate the embodiments of the invention, but are not intended to limit the scope thereof. All parts and percentages are by weight unless otherwise indicated.

The following materials were used:

| | |
|---|---|
| DABCO 33 LV | A 33% solution of triethylenediamine in propylene glycol |
| | available from Air Products & Chemicals Inc. |
| DABCO T9 | A stannous octoate catalyst available from Air Products |
| | & Chemicals Inc. |
| Diethanolamine | 85% or 99% purity, available from the Sigma-Aldrich |
| | Co. |
| HCFC 141b | 1,1-dichloro-1-fluoroethane, available from Solvay S.A. |
| KOSMOS 29 | A stannous octoate catalyst available from Evonik |
| | Industries. |
| KOSMOS 54 | A zinc ricinoleate catalyst available from Evonik |
| | Industries. |
| NIAX A-1 | A tertiary amine catalyst available from Momentive |
| | Performance Materials. |
| NIAX A-300 | A tertiary amine catalyst available from Momentive |
| | Performance Materials. |
| NIAX A-400 | A delayed action cell opening amine blow catalyst |
| | available from Momentive Performance Materials. |
| NIAX L-540 | A silicone surfactant available from Momentive |
| | Performance Materials. |
| NIAX L-620 | A silicone surfactant for polyether flexible slabstock |
| | foam available from Momentive Performance Materials. |
| NIAX L-627 | A low viscosity silicone surfactant for low resilience |
| | flexible slabstock foam available from Momentive |
| | Performance Materials. |
| NIAX L-660 | A silicone surfactant available from Momentive |
| | Performance Materials. |
| NIAX L-703 | A silicone surfactant for polyether flexible slabstock |
| | foam available from Momentive Performance Materials. |
| NOPB A | Soybean oil based polyol prepared according to examples |
| | 19-22 of WO 2004/096882. The monomers are |
| | hydroxymethylated soybean fatty acid methyl esters and |
| | the initiator is a 625 molecular weight poly(ethylene |
| | oxide) triol used at a ratio of monomer to initiator of |
| | 4.1:1. NOPB A has a hydroxyl number of 89. |
| NOPB B | A soybean oil based polyol prepared according to |
| | Example 6 of copending Patent Application No. |
| | PCT/US09/37751, filed on Mar. 20, 2009, entitled |
| | “Polyether Natural Oil Polyols and Polymers Thereof” |
| | the entire contents of which are incorporated herein by |
| | reference. NOPB B has a hydroxyl number of 29. |
| ORTEGOL 75 | A poly(dimethyl Siloxane:styrene) surfactant available |
| | from Evonik. |
| ORTEGOL 204 | A block stabilizer available from Evonik Industries. |
| Polyol A | A 1,000 equivalent weight mixed feed EO/PO tetrol |
| | initiated with 3,3′-diamino-N-methyl dipropylamine |
| | containing 15% Ethylene oxide. Polyol A has an OH |
| | number of 56. |
| SILBYK 9715 | A surfactant for the production of HR flexible slabstock |
| | foams. |
| SILWET L-7500 | A 3000 molecular weight polyalkylene oxide |
| | polysiloxane having butyl capped propylene oxide on a |
| | siloxane backbone, available from Momentive |
| | Performance Materials. |
| SILWET L-7600 | A 4000 molecular weight weight polyalkylene oxide |
| | polysiloxane having methyl capped ethylene oxide on a |
| | siloxane backbone, available from Momentive |
| | Performance Materials. |
| SILWET L-7604 | A 4000 molecular weight weight polyalkylene oxide |
| | polysiloxane having hydrogen capped ethylene oxide on |
| | a siloxane backbone, available from Momentive |
| | Performance Materials. |
| SILWET L-7605 | A 6000 molecular weight weight polyalkylene oxide |
| | polysiloxane having methyl capped ethylene oxide on a |
| | siloxane backbone, available from Momentive |
| | Performance Materials. |
| SILWET L-7622 | A 10000 molecular weight weight polyalkylene oxide |
| | polysiloxane having methyl capped ethylene oxide on a |
| | siloxane backbone, available from Momentive |
| | Performance Materials. |
| TEGOSTAB B-1903 | A foam stabilizer based on a polyether-modified |
| | polysiloxane available from Degussa-Goldschmidt |
| | Corporation. |
| TEGOSTAB B-8715 | A silicone surfactant available from Degussa- |
| | Goldschmidt Corporation. |
| TEGOSTAB B-8719 | A silicone surfactant available from Degussa- |
| | Goldschmidt Corporation. |
| TEGOSTAB BF-2370 | A Polysiloxane polyoxyalkylene block copolymer for |
| | flexible polyurethane slabstock and molded |
| | foams. available from Degussa-Goldschmidt Corporation. |
| VORALUX* HN 380 | A styrene-acrylonitrile based copolymer polyol having a |
| | hydroxyl number of 29, available from The Dow |
| | Chemical Company |
| VORANATE* T-80 | A toluene diisocyanate (80% 2,4-toluene diisocyanate |
| | and 20% 2,6-toluene diisocyanate by weight) |
| | composition available from The Dow Chemical |
| | Company. |
| VORANOL* 2110 | A propylene oxide polyether diol available from The |
| | Dow Chemical Company. |
| VORANOL* 3010 | A glycerine initiated polyether polyol with a nominal |
| | 3000 molecular weight. Available from The Dow |
| | Chemical Company. |
| VORANOL* CP 1421 | A 1700 equivalent weight triol of 25 percent propylene |
| | oxide and 75 percent ethylene oxide available from The |
| | Dow Chemical Company. |

*VORACTIV, VORALUX, VORANOL and VORANATE are trademarks of The Dow Chemical Company.

Foam Examples E1-E24 and Comparative Example 1 were prepared as follows:

All materials, except the isocyanate and tin catalyst (VORANATE T-80 and DABCO T9, respectively), were combined in the amounts indicated in the following tables, and are mixed for 60 seconds using a stirrer at 1,000 RPM. The tin catalyst (DABCO T9) was then added, and the mixture mixed for 30 seconds at 1,000 RMP. Isocyanate (VORANATE T-80) was added, the mixture mixed for six seconds at 2,500 RMP, and then the mixture was poured into a 40 cm×40 cm×40 cm wooden box lined with plastic and left to rise freely. After a few minutes the foam was removed from the wooden box and let cure at room temperature for at least 24 hours.

Foam yellowing is determined as follows: Three pieces of foam measuring about 7 cm×7 cm×3 cm were cut from about the center of the foam using a ribbon saw. The whiteness of the foams was measured using a Color Touch 2 spectrophotometer (Technidyne Corporation). The measurements were performed using ISO Standard 2469, and the spectrophotometer light source was set to the D-65 option which simulates outdoor daylight. The observer was set to the 2° observer. Whiteness was measured at five points on one of the surfaces (one at close to the center of the surface and four at the extremities of the surface) of each piece of foam. Thus, each foam preparation thus has 15 whiteness measurements which are averaged to represent the initial color measurement of the foam preparation.

The results are reported as CIE whiteness, where the larger the CIE whiteness value of a sample is, the greater the whiteness (absence of color) of the sample is.

After the whiteness was measured, the foam samples were randomly placed inside a black lined box with a 32 W LUMILUX Cool White light bulb disposed 34 cm above the samples. The samples were illuminated for 35 days. Each third day, the samples were randomly repositioned. Color measurements were then performed again, and change in CIE whiteness (Δ CIE whiteness) were calculated by subtracting the CIE whiteness value after light exposure from the initial value.

Water absorption was measured as follows: The weight of a piece of foam was determined and the foam immersed in water for 30 seconds. The piece of foam was then taken out of the water and let drip for ten seconds. The wet piece of foam was then weighed, as well as the water collected from the dripping, and the percent weight increase (water uptake) is determined

Density is measured according to the procedures of NBR 8537 (issued by ABNT, Associação Brasileira de Normas Técnicas) after removal of any skin that forms on the surface of the free rise foam pad.

Air flow is the volume of air which passes through a 1.0 inch (2.54 cm) thick 2 inch×2 inch (5.08 cm) square section of foam at 125 Pa (0.018 psi) of pressure. Units are expressed in cubic decimeters per second and converted to standard cubic feet per minute. A representative commercial unit for measuring air flow is manufactured by TexTest AG of Zurich, Switzerland and identified as TexTest Fx3300. This measurement follows ASTM D 3574 Test G and NBR 8517.

Tensile and Elongation values are determined according to the procedures of NBR 8515.

Tear Resistance is determined according to the procedures of NBR 8516.

Indentation Force Deflection is determined according to the procedures of NBR 9176.

Resilience is measured according to the procedures of NBR 8619.

### Comparative Example 1 and Examples 1-11

Comparative example 1 (CE1) and examples 1-11 (E1-E11) were produced as described above using materials in the amounts listed in Table 1. Physical properties of the same foam samples are given in Table 2. Comparative example CE1 is a standard formulation for a polyurethane foam based on a conventional non-natural oil based polyol. As can be seen from the results in Table 1 and Table 2, foams made using a high amount of natural oil based polyols have similar physical properties as Comparative example 1. The formulation for Example E4 resulted in a collapsed foam. The formulations for Examples E5-E11 do not include an amine catalyst and hence no amine odor is observed.

Three of these foam samples (CE1, E1 and E2) were tested for foam yellowing. As seen in Table 3, the tested two foams made with a high amount of natural oil based polyols (E1 and E2) has much lower yellowing than the foam based on a conventional non-natural oil based polyol (CE1).

Two foam samples (CE1 and E8) were tested for their water uptake capabilities. The results are given in Table 4. From the results it can be seen that the tested foam made using a high amount of natural oil based polyols (E14) has almost a four times greater rate of absorption than the foam based on a conventional non-natural oil based polyol (CE1). Furthermore, the foam maintains its integrity as it is exposed to the water, and it does not lose its structural strength.

TABLE 1

| | CE1 | E1 | E2 | E3 | E4 | E5 | E6 | E7 | E8 | E9 | E10 | E11 |
|---|---|---|---|---|---|---|---|---|---|---|---|---|
| VORANOL 2110 | 20 | 15 | 15 | 15 | 15 | 13 | 25 | 30 | 23 | 23 | 23 | 28 |
| NOBP A | — | 85 | 85 | 85 | 85 | 85 | 75 | 70 | 75 | 75 | 75 | 70 |
| VORANOL CP 1421 | — | — | 2 | — | — | 2 | — | — | 2 | 2 | 2 | 2 |
| VORANOL 3010 | 80 | — | — | — | — | — | — | — | — | — | — | — |
| POLYOL A | — | — | — | — | — | — | — | — | — | 1 | — | 2 |
| HCFC 141b | — | — | — | — | — | 1.5 | — | — | — | — | — | — |
| Water | 4 | 4 | 4 | 4 | 4 | 3.75 | 4 | 4 | 4 | 4 | 4 | 4.2 |
| SILWET L-7605 | — | 1 | 1 | 1 | 1 | 1 | 1 | 1 | 1 | 1 | 1 | 1 |
| NIAX L-660 | — | — | — | — | — | — | — | — | — | 1 | — | — |
| ORTEGOL 75 | — | — | — | — | — | — | — | — | — | — | 1 | — |
| TEGOSTAB B-1903 | — | 0.5 | — | — | — | — | — | — | — | — | — | — |
| NIAX A-300 | — | — | — | — | 0.3 | — | — | — | — | — | — | — |
| NIAX A-400 | — | — | — | — | 0.12 | — | — | — | — | — | — | — |
| NIAX L-703 | — | — | — | — | — | — | 1 | 1 | 1 | 0.5 | 0.5 | — |
| NIAX L-540 | 1 | 1 | 1 | 0.2 | 1 | 1 | — | — | — | — | — | 1 |
| NIAX A-1 | 0.1 | 0.12 | 0.12 | 0.12 | — | — | — | — | — | — | — | — |
| DABCO 33 LV | — | 0.3 | 0.3 | 0.3 | — | — | — | — | — | — | — | — |
| DABCO T9 | 10.12 | 0.07 | 0.12 | 0.12 | 0.08 | 0.12 | 0.1 | 0.1 | 0.15 | 0.15 | 0.15 | 0.13 |
| VORANATE T-80 | 51 | 49.5 | 52 | 52 | 52 | 55.5 | 56 | 56 | 56 | 56 | 56 | 55 |
| Index | 104 | 95.00 | 100.00 | 100.00 | 100.00 | 110.00 | 105.00 | 105.00 | 105.00 | 105.00 | 105.00 | 100 |

TABLE 2

| | CE1 | E1 | E2 | E3 | E4 | E5 | E6 | E7 | E8 | E9 | E10 | E11 |
|---|---|---|---|---|---|---|---|---|---|---|---|---|
| Estimated renewable | 1 | 42 | 42 | 42 | 42 | 42 | 38 | 35 | 38 | 38 | 38 | 35 |
| carbon content (%) | | | | | | | | | | | | |
| Density (kg/m³) | 27.7 | 22.0 | 23.6 | — | 23.0 | 24.8 | 24.5 | 25.3 | 24.4 | 25.9 | 23.1 | 22.7 |
| Air Flow (cfm) | 2.7 | 0.4 | 0.4 | — | 0.3 | 0.4 | 1.3 | 1.3 | 2.4 | 0.5 | 0.5 | 0.6 |
| Tensile Strength(kPa) | 55 | 51 | 35 | — | 64 | 91 | 84 | 90 | 88 | 60 | 54 | 161 |
| Elongation (%) | 142.7 | 127 | 84 | — | 124.0 | 100.0 | 126.7 | 153.3 | 126.7 | 101.3 | 104.0 | 69 |
| Tear Resistance (N/m) | 568.05 | 277 | 239 | — | 327.71 | 493.20 | 389.55 | 519.81 | 457.08 | 322.09 | 252.27 | 479 |
| IFD 25% (N) | 89 | 37 | 65 | — | 110 | 135 | 179 | 140 | 176 | 203 | 149 | 72 |
| IFD 40% (N) | 145 | 76 | 90 | — | 155 | 189 | 237 | 243 | 243 | 271 | 200 | 105 |
| IFD 65% (N) | 301 | 182 | 155 | — | 287 | 337 | 418 | 425 | 422 | 462 | 344 | 219 |
| Resilience (%) | 46.3 | 25 | 16.6 | — | 24.3 | 16.8 | 22.9 | 21.4 | 28.6 | 23.6 | 19.1 | 18 |

TABLE 3

| | | | Δ |
|---|---|---|---|
| | Initial Value | Final Value | Whiteness |
| Example | Whiteness CIE | Whiteness CIE | CIE |
| E1 | 78.01 | 25.81 | 52.20 |
| E2 | 78.20 | 27.66 | 50.54 |
| CE1 | 84.90 | −11.24 | 96.14 |

TABLE 4

| | CE1 | | E8 | |
|---|---|---|---|---|
| | Test 1 | Test 2 | Test 1 | Test 2 |
| Dry Weight (g) | 3.60 | 3.88 | 5.20 | 4.50 |
| Wet Weight (g) | 14.35 | 17.00 | 67.50 | 60.12 |
| Increase (%) | 298.61 | 338.14 | 1198.08 | 1236.00 |

| | | |
|---|---|---|
| Average Increase (%) | 318.38 | 1217.04 |

### Comparative Example 2 and Examples 12-16

The effect of increased amount of natural oil based polyol used in the foam formulations in respect to yellowing was examined. Comparative Example 2 (CE2) and Examples 12-16 (E12-E16) were produced as described above using materials in the amounts listed in Table 5. Yellowing effect results after 35 days are given in Table 6.

TABLE 5

| | CE2 | E12 | E13 | E14 | E15 | E16 |
|---|---|---|---|---|---|---|
| NOBP A | 0 | 20 | 40 | 60 | 80 | 100 |
| VORANOL 3010 | 100 | 80 | 60 | 40 | 20 | 0 |
| Water | 4.2 | 4.2 | 4.2 | 4.2 | 4.2 | 4.2 |
| SILWET L-7605 | 1 | 1 | 1 | 1 | 1 | 1 |
| NIAX L-540 | 1 | 1 | 1 | 1 | 1 | 1 |
| DABCO T9 | 52 | 53 | 54 | 55 | 56 | 57 |
| VORANATE | 52 | 53 | 54 | 55 | 56 | 57 |
| T-80 | | | | | | |
| Index | 105.00 | 105.00 | 105.00 | 105.00 | 105.00 | 105 |
| Estimated | 1 | 11 | 21 | 31 | 40 | 49 |
| renewable carbon | | | | | | |
| content (%) | | | | | | |

TABLE 6

| | Initial Value | Final Value | Δ |
|---|---|---|---|
| | Whiteness | Whiteness | Whiteness |
| Formulation | CIE | CIE | CIE |
| CE2 | 69.9 | −85.3 | 155.2 |
| E12 | 69.74 | −71.47 | 141.2 |
| E13 | 70.33 | −67.90 | 138.2 |
| E14 | 70.19 | −55.36 | 125.5 |
| E15 | 68.65 | −49.95 | 118.6 |
| E16 | 65.39 | −39.42 | 108.8 |

### Examples 17-21

The effect of various polyalkylene oxide polysiloxane surfactants used in the foam formulations was examined Examples 17-21 (E17-E21) were produced as described above using materials in the amounts listed in Table 7. Physical properties of the same foam samples are also given in Table 7. Yellowing effect results are given in Table 8. The formulation for Example E19 resulted in a collapsed foam.

TABLE 7

| | E17 | E18 | E19 | E20 | E21 |
|---|---|---|---|---|---|
| NOBP A | 100 | 100 | 100 | 100 | 100 |
| SILWET L-7622 | — | — | 1 | — | — |
| Water | 3 | 3 | 3 | 3 | 3 |
| SILWET L-7605 | 1 | — | — | — | 1 |
| SILWET L-7600 | — | 1 | — | — | — |
| SILWET L-7604 | — | — | — | — | 1 |
| NIAX L-540 | 1 | 1 | 1 | 1 | 1 |
| SILWET L-7500 | — | — | — | 1 | — |
| DABCO T9 | 0.1 | 0.1 | 0.1 | 0.1 | 0.1 |
| VORANATE T-80 | 45 | 45 | 45 | 45 | 45 |
| Index | 105.00 | 105.00 | 105.00 | 105.00 | 105.00 |
| Estimated | 52 | 52 | 52 | 52 | 52 |
| renewable carbon | | | | | |
| content (%) | | | | | |
| Density (kg/m³) | 31.7 | 33.9 | — | 31.4 | 32.6 |
| Air Flow (cfm) | 0.4 | 0.4 | — | 0.3 | 0.5 |
| Tensile Strength | 49 | 55 | — | 63 | 50 |
| (kPa) | | | | | |
| Elongation (%) | 88.0 | 84.0 | — | 92.0 | 88.0 |
| Tear Resistance | 265.84 | 248.05 | — | 326.55 | 350.94 |
| (N/m) | | | | | |
| IFD 25% (N) | 90 | 96 | — | 86 | 94 |
| IFD 40% (N) | 131 | 139 | — | 128 | 137 |
| IFD 65% (N) | 254 | 273 | — | 255 | 266 |
| Resilience (%) | 17.7 | 16.7 | — | 15.7 | 19.6 |

TABLE 8

| | Initial Value | Final Value | Δ |
|---|---|---|---|
| | Whiteness | Whiteness | Whiteness |
| Formulation | CIE | CIE | CIE |
| E17 | 57.16 | 21.48 | 35.68 |
| E18 | 63.00 | 23.82 | 39.19 |
| E20 | 66.60 | 26.20 | 40.40 |
| E21 | 58.27 | 18.82 | 39.46 |

### Comparative Examples 3 and 4 and Examples 22 and 23

Foams Examples E22 and E23 and Comparative Examples CE3 and CE4, were prepared as follows: All materials of were combined and conditioned at 25° C. in the amounts indicated in the following tables. First, all materials, except for the gelation catalyst (KOSMOS 29) and isocyanate (VORANATE T-80) were combined and mixed for 25 seconds. At 25 seconds gelation catalyst was added under stirring with VORANATE T-80 added ten seconds later. After an additional ten seconds, the mixture was poured into a 10 liter bucket lined with plastic and left to rise freely. After a few minutes the foam was removed from the bucket and let cure at room temperature for at least 12 hours. Table 9 includes the amounts of materials used and a description of the resulting foam.

TABLE 9

| | CE2 | CE3 | E22 | E23 |
|---|---|---|---|---|
| NOPB B | | | 70 | 70 |
| SPECFLEX NC 700 | 30 | 30 | 30 | 30 |
| VORANOL 4820 | 70 | 70 | | |
| Diethanolamine (99%) | 0.51 | 0.51 | 0.51 | 0.51 |
| NIAX A-1 | 0.1 | 0.1 | 0.1 | 0.1 |
| DABCO 33LV | 0.15 | 0.15 | 0.15 | 0.15 |
| ORTEGOL 204 | 1.8 | 1.8 | 1.8 | 1.8 |
| KOSMOS 29 | 0.1 | 0.2 | 0.1 | 0.2 |
| SILWET L-7605 | 0.2 | 0.2 | 0.2 | 0.2 |
| Water | 1.59 | 1.59 | 1.59 | 1.59 |
| VORANATE T-80 | 100 | 100 | 100 | 100 |
| Index | 110 | 110 | 110 | 110 |
| Parts | 30.6 | 30.6 | 29.8 | 29.8 |
| Estimated renewable | 1 | 1 | 14 | 14 |
| carbon content (%) | | | | |
| Observed Foam Property | Massive | Massive | Stable | Some |
| | shrinkage | shrinkage | open foam | Shrinkage |

As the stannous octoate (KOSMOS 29) level is reduced, the foam becomes less stable and some settle takes place. When the VORANOL 4820 is replaced with NOPB B polyol (Examples E22 and E23), a non-standard silicone, such as SILWET L-7605, may be used to achieve a stable block. Similar block shapes are observed for the NOPB B based foams as for the conventional non-renewable formulations.

However, when non-standard silicone (for example, SILWET L-7605) is used in the standard conventional non-renewable resource based high resilience foams formulations, it is observed that massive shrinkage takes place due to over stabilization and the presence of closed cells. These results present the very different silicone requirements for standard versus and natural oil based polyols.

While the foregoing is directed to embodiments of the present invention, other and further embodiments of the invention may be devised without departing from the basic scope thereof, and the scope thereof is determined by the claims that follow.

1. A polyurethane foam, comprising a reaction product of at least:
at least one isocyanate; and
at least one natural oil based polyol, wherein the at least one isocyanate and the at least one natural oil based polyol are reacted in the presence of at least one polyalkylene oxide polysiloxane having the formula:
R¹—CH₃)₂SiO—[(CH₃)₂SiO]ₐ—[(CH₃)(R¹)SiO]_{b}—Si(CH₃)₂R¹
wherein a+b are from about 1 to about 50, and each R¹ is the same or different and is selected from the group consisting of methyl and a poly(ethyleneoxide/propyleneoxide) copolymer group having the general formula:
—(CH₂)ₙO(C₂H₄O)_{c}(C₃H₆O)_{d}R²
with at least one R¹ being a poly(ethyleneoxide/propyleneoxide) copolymer group, and wherein n is 3 or 4, total c has a value of from 1 to about 100, total d is from 0 to about 14, total c+d has a value of from about 5 to about 150, and each R² is the same or different and is selected from the group consisting of hydrogen, an alkyl having 1 to 4 carbon atoms, and an acetyl group; and
wherein the polyurethane foam has at least 40% renewable carbon content based on the total carbon content of the foams and has at least one of a tear resistance of at least 250 N/m and a tensile strength of at least 80 kPa.

2. The polyurethane foam of any one of claim 1, wherein the tear resistance is at least 250 N/m and the tensile strength is at least 80 kPa.

3. The polyurethane foam of either claim 1 or claim 2, wherein the renewable carbon content is at least 50%.

4. The polyurethane foam of either claim 1 or claim 2, wherein the foam has a resilience of at least of about 35%.

5. The polyurethane foam of claim 4, wherein the resilience is at least about 45%.

6. The polyurethane foam of claim 1, wherein the foam has no amine catalyst based volatile organic compounds emissions.

7. The polyurethane foam of claim 1, wherein the foam can absorb at least five times its own weight in water after immersion in water for 30 seconds.

8. The foam of claim 7 wherein the foam can absorb at least 10 times its own weight in water after immersion in water for 30 seconds.

9. The polyurethane foam of claim 1, wherein the at least one natural oil based polyol comprises at least one of a hydroxymethylated fatty acid and a hydroxymethylated fatty acid ester.

10. The polyurethane foam of claim 1, wherein the at least one natural oil based polyol comprises at least two natural oil moieties separated by at least one of a molecular structure having an average of at least about 19 ether groups between any 2 of the natural oil moieties and a polyether molecular structure having an equivalent weight of at least about 400.

11. The polyurethane foam of claim 1, wherein the foam has loss of CIE whiteness of less than about 50 after exposure to simulated outdoor daylight for 35 days.

12. The polyurethane foam of claim 11, wherein the loss of CIE whiteness is less than about 40.

13. An article of manufacture comprising the polyurethane foam of claim 1.

14. The article of manufacture of claim 13, being selected from bra pads, chair cushions, basket ball pole padding, bed wedges, boat seats, bolsters, bunk beds, cabin cruiser beds, camping beds, camping pads, car and truck seats, car and truck interior, case padding, chair arms and backs, church pews, concrete pipe cleaning, cot cushioning, day beds, day care toys, dining room chairs, display models, exercise mats, fabric backing, floor padding, gymnastics or karate pads, motor home beds and seats, mattresses, motorcycle seats, packaging material, physical therapy fixtures, pillows, roll a way beds, sound proofing, scrubbers, shoulder pads, sofa cushions, sponges, wall padding, and window seats.

15. A method for producing the polyurethane foam, comprising reacting at least:
at least one isocyanate; with
at least one natural oil based polyol, wherein the at least one isocyanate and the at least one natural oil based polyol are reacted in the presence of at least one polyalkylene oxide polysiloxane having the formula:
R¹—CH₃)₂SiO—[(CH₃)₂SiO]ₐ—[(CH₃)(R¹)SiO]_{b}—Si(CH₃)₂R¹
wherein a+b are from about 1 to about 50, and each R¹ is the same or different and is selected from the group consisting of methyl and a poly(ethyleneoxide/propyleneoxide) copolymer group having the general formula:
—(CH₂)ₙO(C₂H₄O)_{c}(C₃H₆O)_{d}R²
with at least one R¹ being a poly(ethyleneoxide/propyleneoxide) copolymer group, and wherein n is 3 or 4, total c has a value of from 1 to about 100, total d is from 0 to about 14, total c+d has a value of from about 5 to about 150, and each R² is the same or different and is selected from the group consisting of hydrogen, an alkyl having 1 to 4 carbon atoms, and an acetyl group.
